(19) United States
(12) Patent Application Publication
(10) Pub. No.: US 2021/0382865 A1
(43) Pub. Date: Dec. 9, 2021

(54) SECURE MODEL ITEM TRACKING SYSTEM

(71) Applicant: ACT, INC., Iowa City, IA (US)

(72) Inventors: Donna Matovinovic, Edmonton (CA); Hollis Lai, Edmonton (CA); Vasily Tanygin, Edmonton (CA); Mark Gierl, Edmonton (CA)

(21) Appl. No.: 16/896,418

(22) Filed: Jun. 9, 2020

(51) Int. Cl. G06F 16/22; G06Q 10/10; G06Q 50/20; G06Q 30/00; G06N 3/00; H04L 29/06

(52) U.S. Cl. CPC G06F 16/2246; G06Q 10/105; G06Q 50/205; H04L 63/0428; G06N 3/008; H04L 63/08; G06Q 30/0185

(57) ABSTRACT

The present disclosure is directed to system and methods for tracking and securing computer generated items using a novel data structure. The MIG data structure may include an item generation model, a revision history log, an item history log, model metadata, and administration information. The system may encrypt the MIG data structure to secure access and usage and perform a decryption process of the MIG data structure upon authenticating and authorizing a user device. The MIG data structure may automatically generate test items using the item generation model. The generated items may be stored and tracked in the item history log of the MIG data structure whereby modifications, revisions, or updates to the MIG data structure may be tracked in the revision history log of the MIG data structure. The MIG data structure may implement a Merkle tree to store the relationship between item generation models and generated items.

### DESCRIPTION OF RELATED ART

The disclosure herein relates to a novel system for securing and tracking items generated from an item generation methods and various cognitive models. Examples of an automatic item generation method based on cognitive modeling can be found in U.S. Patent Publication No. 2014/0214385 to Gierl et al. (Gierl). Gierl teaches a process for generating test items comprising a templated approach through the use of cognitive modeling and item modeling. Producing a cognitive model may include, for example, defining a problem scenario, identifying sources of information for the problem, and logically interrelating elements and constraints of the sources of information. The method generates test items by using a computer algorithm to place the content of a cognitive model into an item model.

### FIELD

The present disclosure relates generally to computer generated assessments. Specifically, to a method of and system for tracking and securing computer generated items for educational assessments (e.g. test items). As would be apparent to a person of ordinary skill in the art, the systems and methods described herein may be applied outside of the educational context without departing from the scope of the disclosure as described herein and in the claims. For example, the systems and methods described herein may be applicable to digital and virtual assets, particularly non-fungible digital or virtual assets.

### BACKGROUND

Teacher, publishers of educational resources, professional licensure organizations, and educational institutions (schools, universities, districts, and states) have the need to administer tests or examinations to determine learning comprehension. Traditionally, standardized test creation is often a laborious task requiring resources to handcraft, revise, and edit individual test items. Further, as demand for test items grows, there is a need to create and administer large numbers of test items, particularly for standardized examinations. Administering a large number of items risks the inclusion of duplicate items within the same test or the exposure of certain test items across different testing facilities. There exist solutions to automate the creation of test items involving an item model which produces items and their associated answers to administer in the digital examinations. Individual entities or parties can create item models in order to create a large number of test items for examinations. Yet, as ease of item creation increases and automated test creation becomes more advanced, there is an increased need to share, distribute, and verify item models. This need creates security risks and extreme complexity of tracking of item models and test items generated from the item models. Previously, for example, if another entity was able to obtain an item set or item model, they would be able to generate and use those items without constraint, increasing the risk of item exposure.

Currently, item models are written in standard web languages such as Extensible Markup Language (XML) compatible format, where all logic and permutation of the generated items are expressed in an easily readable format. Item models, as currently written, are vulnerable to reverse engineering from competitors or malicious entities for item generation and other item generators if such file is leaked. Moreover, no user access and control exists to specifically control how an item generation model can be accessed and used. Although item generation is traditionally tracked, no user information is captured regarding usage information such as who used which item, and when the item was administered in a live test environment. The security and tracking of item use is currently done at the individual item level. No system currently exist in tracking at the item model level. Tracking item generation systems is currently done in a laborious manner that often involves manual audits to track item generation and usage history.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an illustrates a diagram of a computing system for tracking and securing computer generated items, in accordance with the embodiments disclosed herein.

FIG. 2 illustrates a diagram of a MIG data structure, in accordance with the embodiments disclosed herein.

FIG. 3 illustrates a Merkle tree of the item history log of an MIG data structure containing information about the relationship between item generation models and generated items, in accordance with the embodiments disclosed herein.

FIG. 4 illustrates a flowchart diagram for creating and MIG data structure and generating test items, in accordance with the embodiments disclosed herein.

FIG. 5 illustrates a flowchart diagram for modifying a MIG data structure, in accordance with the embodiments disclosed herein.

The figures are not exhaustive and do not limit the present disclosure to the precise form disclosed.

### BRIEF DESCRIPTION OF THE EMBODIMENTS

The present disclosure is directed to systems and methods for tracking and securing computer generated items for digital assessments. For example, in some implementations, the generated items for educational assessment may be tracked and secured through a Model Item Generation (MIG) data structure that includes an item generation model, revision history log, item history log, model metadata, and administration information. In some implementations, the item generation model specifies the elements and structure of the generated items. More specifically, in the context of generating, modifying, and tracking items that are used in digital examinations, embodiments disclosed herein enable secure distribution of item generation models used to generate items for digital assessments. The security and traceability of computer generated items is enhanced by utilizing cryptographic techniques such as hashing, public-private key encryption, and digital signatures. Furthermore, data integrity of this process is improved by structuring the usage history of item generation models, along with the item generation models themselves in a single exportable data structure. The creation, modification and usage (e.g. item generation) of item generation models are all secured and tracked in a data structure that ensures enhances security and traceability over traditional solutions to generate, modify, and track items. Moreover, the systems and methods disclosed herein improve the efficiency regarding the auditing an item generation model by storing the creation, modification and usage of item generation models in data structures optimized for verification and access such as hash tables Merkle trees.

In some embodiments, the system for tracking and securing computer generated items may include a computing device configured to communicate with a user device over a network, the computing device comprising a processor and a graphical user interface and a non-transient memory with computer executable instructions embedded. In some embodiments, the computer executable instructions may be configured to cause the processor to, authenticate and authorize the user device, grant the user device access to an encrypted model item generation (MIG) data structure, decrypt the MIG data structure, generate a plurality of items based upon the item generation model and model metadata, and record the plurality of generated items in the item history log.

In some embodiments, authenticating and authorizing the user device may include validating the user device credentials and retrieving access rights of the user device, respectively. In some embodiments, the item history log may further include a Merkle tree. In some embodiments, the root of the Merkle tree may be associated with the item history log, the non-leaf nodes of the Merkle tree may be associated with the item generation model, and each leaf of the Merkle tree is associated with a generated item. In some embodiments, modifications to the item generation model creates a new non-leaf node of the Merkle tree. In some embodiments, modifications to the item generation model include modifications to the administration information, and modifications to the model metadata are recorded in the revision history log of the MIG data structure.

In embodiments, the item generation model may include test item templates, variable elements, content values, and associated answers. In some embodiments, the test item templates are used in a process for generating items comprising varying the variable elements in the test item templates with the content values and determining the associated answers. In some embodiments, the test item templates may include an n-layer model. In some embodiments, items are tagged with the model metadata. The model metadata may be specified by the user device that created the item generation model. For example, the plurality of generated items are processed through a hashing algorithm to determine the unique hash for each generated item. The unique hash may be used to identify items, check for duplicates, and determine the relationship between the item generation model and the item. In some embodiments, the system may include system metadata. In some embodiments, system metadata may include system level authorization settings, usage logs, user device information, and a historical item generation log of all items generated in the system.

Also disclosed is a computer-implemented method for tracking and securing computer generated items. In some embodiments, the method includes authenticating and authorizing a user device, granting the user device access to an encrypted model item generation (MIG) data structure, decrypting the stored MIG data structure stored in, invoking the MIG data structure to generate a plurality of test items, determining the uniqueness of the generated items, and recording the plurality of generated items in the item history log.

### DETAILED DESCRIPTION

Embodiments of the technology disclosed herein are directed toward a method and system for tracking and securing computer generated items by utilizing a model item generation (MIG) data structure that implements cryptography, Merkle trees, layered authorization and access systems, secure file transfer, and secure storage systems. The MIG data structure may an encrypted, exportable, and store self-contained information regarding computer generated items. More specifically, examples of the disclosed technology apply to cryptography, digital data structures, and secure usage/tracking systems. In some embodiments, the method and system may store the multi-tiered encrypted MIG data structure in a database.

Typically, automatic item generation (AIG) utilize models designed by a test specialist of subject matter expert which is then used to generate test items that are administered to examinees. Examples of automatic item generation can be found in U.S. Patent Publication No. 2014/0214385 to Gierl et al. (Gierl), which is incorporate in its entirety herein by reference. As AIG becomes more prevalent in education examination administration, the complexity of both the trackability and security of the computer generated items is intensified. Furthermore, the need to secure and track the information is becoming increasingly important because of the critical tests and examinations where AIG is being used. The critical nature and significant complexity of AIG systems require a robust and fault-tolerant system to ensure the security, integrity, and auditability of computer generated items. Currently, there are no systems that effectively secure and track computer generated items produced by AIG models. Preferred systems and methods which address one or more of the problems known in the art are described hereinafter, by way of particular examples. It will be apparent to persons skilled in the art that a number of variations and modifications can be made without departing from the scope of the disclosure as defined in the claims.

In some embodiments, the disclosed platform may include a computerized system for securely generating and distributing cryptographically secure, test items associated with an item generation model of a MIG data structure. In some embodiments, the system may include a user interface configured to receive input from one or more parties interacting with a blockchain network. In some embodiments, at least a portion of the received input may be recorded on the blockchain network. Information may include information pertaining to a MIG data structure, components of an MIG data structure such as a computer generated item, or a confirmation from one or more identified parties in the form of a digital authentication. In implementations, the parties may interact with the blockchain network through a user interface that uses a software bridge to communicate and receive information to and from the blockchain network.

In some embodiments, the system may include a virtual machine operating on the blockchain network configured to execute computer-readable code. In certain implementations, the virtual machine may include the Ethereum Virtual Machine or similar programmable blockchain-based virtual machines. In embodiments, the executable computer-readable code may include one or more smart contracts operating on the blockchain network to perform functions requiring input from one or more parties interacting with the system. In some embodiments, the virtual machine may be implemented with of docker containers. For example, the virtual machine may include of multiple Docker containers running Hyperledger Fabric software to invoke, validate, and order transactions.

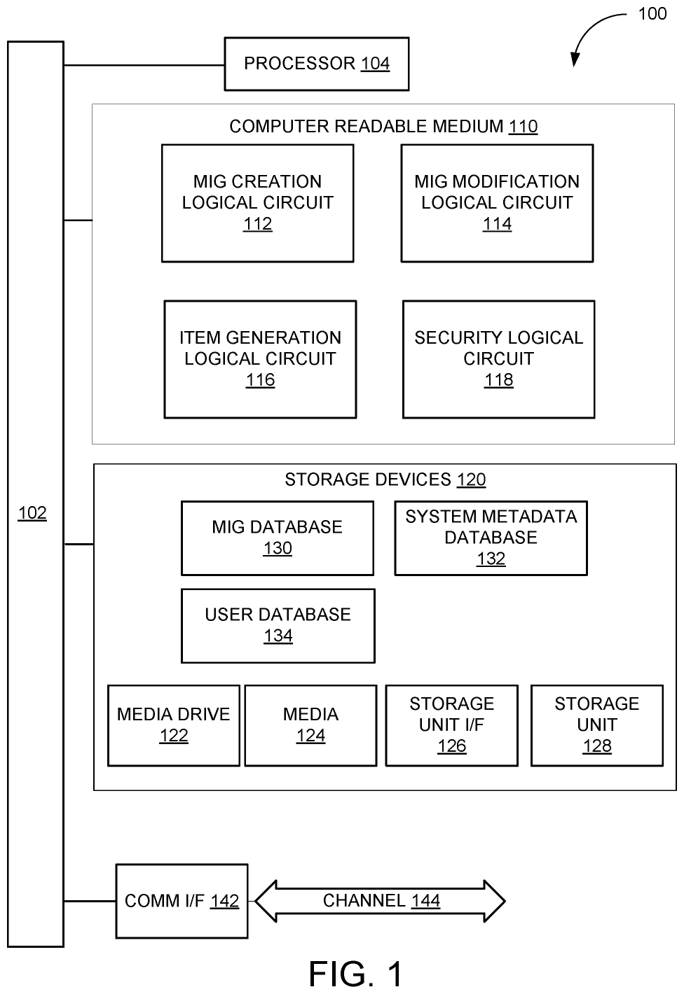

FIG. 1 illustrates a diagram of computing system for tracking and securing computer generated items by utilizing an MIG data structure. The MIG data structure may include encrypted, exportable, and self-contained information relating to computer generated items. Computing system 100 may represent, for example, computing or processing capabilities found within desktop, laptop, and notebook computers; hand-held computing devices (PDA's, smart phones, cell phones, palmtops, etc.); mainframes, supercomputers, workstations or servers; distributed computing systems, or any other type of special-purpose or general-purpose computing devices as may be desirable or appropriate for a given application or environment. Computing system 100 may also represent computing capabilities embedded within or otherwise available to a given device. For example, a computing system may be found in other electronic devices such as, for example, digital cameras, navigation systems, cellular telephones, portable computing devices, modems, routers, WAPs, terminals and other electronic devices having some form of processing capability.

Computing system 100 may include, for example, one or more processors, controllers, control engines, or other processing devices, such as a processor 104. Processor 104 may be implemented using a general-purpose or special-purpose processing engine such as, for example, a microprocessor, controller, or other control logic. In the illustrated example, processor 104 is connected to a bus 102, although any communication medium may be used to facilitate interactions with other components of computing system 100 or to communicate externally outside of computing system 100.

Computing system 100 may also include one or more memory engines, simply referred to herein as computer readable medium 110. For example, preferably random access memory (RAM) or other dynamic memory, may be used for storing information and instructions to be executed by processor 104. Computer readable medium 110 may also be used for storing temporary variables or other intermediate information during execution of instructions to be executed by processor 104. Computing system 100 may include a read only memory (“ROM”) or other static storage device coupled to bus 102 for storing static information and instructions for processor 104.

In some embodiments, computer readable medium 110 may include one or more logical circuits that may contain optimized logic gates and instructions for specific tasks to be executed by processor 104. Logic gates are virtual or physical devices that implement a Boolean function (e.g. AND, OR, NAND, etc.). Logical circuits may also include virtual or physical devices such as multiplexers, registers, arithmetic logic units (ALUs), and microprocessors. Logical circuits may include temporary or static variables used during the execution of the logical circuits instructions by processor 104.

In some embodiments, computer readable medium 110 may include MIG creation logical circuit 112. In some embodiments, MIG creation logical circuit 112 may include receiving information from other components in the computing system 100, and instantiating an MIG data structure based upon the received information. In some embodiments, an MIG data structure may be a digital object comprising an item generation model, a revision history log, an item history log, system metadata, and administration information. In some embodiments, MIG creation logical circuit 112 may include optimized logic gates and instruction to create and store MIG data structures. For example, the MIG creation logical circuit 112 may partition a section of memory in the storage in system 100 where an MIG data structure is stored. The MIG creation logical circuit 112 may include mapping the identifiable name of the MIG data structure with the storage location of the MIG data structure for subsequent access. In some embodiments, MIG creation logical circuit 112 may include defining components of the MIG data structure from received information from a graphical user interface (GUI). For example, a user may interact with a MIG creation GUI to provide input that defines information required to create different components of the MIG data structure. For example, a user may input the structure of the item generation model, and access rights of users for the MIG data structure being created.

In some embodiments, computer readable medium 110 may include MIG modification logical circuit 114. In some embodiments, MIG modification logical circuit 114 may include accessing an MIG data structure that has been previously created. In some embodiments, the MIG modification logical circuit may communicate with security logical circuit 118 to authorize and authenticate a user device to access a specific MIG data structure. In some embodiments, MIG modification logical circuit 114 may receive information from other components of computing system 100 and modify the accessed/specified MIG data structure from the received information. In some embodiments, MIG modification logical circuit 114 may include optimized logic gates and instructions to modify the MIG data structure. For example, the MIG modification logical circuit 114 may change only specific elements of the MIG data structure being modified as opposed to re-writing the entire MIG data structure. In some embodiments, MIG modification logical circuit 114 may include appending the revision history log in the accessed MIG data structure. In some embodiments, MIG modification logical circuit 114, may create a new non-leaf node in the Merkle tree in the item history log of the MIG data structure.

In some embodiments, computer readable medium 110 may include item generation logical circuit 116. In some embodiments, item generation logical circuit 116 may include accessing an MIG data structure that has been previously created. In some embodiments, the item generation logical circuit 116 may communicate with security logical circuit 118 to authorize and authenticate a user device to access a specific MIG data structure. In some embodiments, item generation logical circuit 116 may utilize the MIG data structure to generate test items. For example, the item generation logical circuit may invoke the execution of the MIGs item generation model to generate test items. In some embodiments, item generation logical circuit 116 may include appending the item history log in the accessed MIG data structure. In some embodiments, item generation logical circuit 116 may include optimized logic gates and instruction to generate and store test items. For example, the item generation logical circuit 116 may determine a location in the partitioned section of memory allocated to the MIG data structure in the storage in system 100 where the test item may be stored. In some embodiments, item generation logical circuit 116 may include comparing a generated test item to the previous item history log of the MIG to determine whether to append the generated item to the item history log. In some embodiments, unique generated items are stored in the history of the item history log. In some embodiments, generated items that are duplicates of test items in the item history log maybe prevented from being stored by item generation logical circuit 116. Such embodiments have the benefit of preventing duplicates test items being administered to the same examinee, same test facility, within a geographic region, or during a period of time. In some embodiments, item generation logical circuit 116, may create a new leaf node in the Merkle tree in the item history log of the MIG data structure.

In some embodiments, computer readable medium 110 may include security logical circuit 118. In some embodiments, security logical circuit 118 may include authorizing and authenticating a user device or user. For example, security logical circuit 118 may validate a digitally signed messaged with a user's public key in order to securely determine a user's identity. In some embodiments, security logical circuit 118 may include retrieving access rights from security database 134 to determine whether or not a user can access a specific MIG. In some embodiments, security logical circuit 118 may include decrypting a stored MIG data structure upon determining process access rights for a specific user. In some embodiments, security logical circuit 118 may include performing encryption and decryption of MIG data structure upon validating proper authenticity and access rights of a user. For example, upon storage of the MIG data structure, security logical circuit may encrypt the MIG data structure with the public key of the owner. Security logical circuit 118 may decrypt the MIG data structure with the owner's private key upon access. This improves the security and usage of the MIG data structures because a user device must not only get properly authorized but also must properly decrypt the MIG data structure in order to use it.

In some embodiments, security logical circuit 118 may include authorizing and authenticating a user based on web session level information from a web browser. For example, security logical circuit 118 may analyze cookies from a user's web browser to authorize and authenticate access to a specific MIG data structure. In some embodiments, security logical circuit 118 may include of a process to quarantine information collected from a user interacting with a graphical user interface (GUI) that is sent to computing system 100. The process of input quarantine, may include of checking for specific patterns of text, such as database queries, bash commands, etc., that could potentially harm the system. In some embodiments, security logical circuit 118 may include of a set of user information that is blocked from accessing the system (blacklist). For example, specific IP addresses, user credentials, organizations, may be blacklisted from using the system if they have previously misused the system.

The computing system 100 may also include one or more various forms of information storage devices 120, which may include, for example, a media drive 122 and a storage unit interface 126. The media drive 122 may include a drive or other mechanism to support fixed or removable storage media 124. For example, a hard disk drive, an optical disk drive, a CD or DVD drive (R or RW), or other removable or fixed media drive may be provided. Accordingly, storage media 124 may include, for example, a hard disk, a floppy disk, magnetic tape, cartridge, optical disk, a CD or DVD, or other fixed or removable medium that is read by, written to or accessed by media drive 122. As these examples illustrate, the storage media 124 can include a computer usable storage medium having stored therein computer software or data. Further, storage media 124 may include a protocol and peer-to-peer network for storing and sharing data in a distributed file system such as, for example, the Interplanetary File System (IPFS).

In some embodiments, information storage devices 120 may include other similar instrumentalities for allowing computer programs or other instructions or data to be loaded into computing system 100. Such instrumentalities may include, for example, a fixed or removable storage unit 128 and an interface 126. Examples of such storage units 128 and interfaces 126 can include a program cartridge and cartridge interface, a removable memory (for example, a flash memory or other removable memory engine) and memory slot, a PCMCIA slot and card, and other fixed or removable storage units 128 and interfaces 126 that allow software and data to be transferred from the storage unit 128 to computing system 100.

In some embodiments, information storage devices 120 may include MIG database 130. In some embodiments, MIG database 130 may include an object-based storage architecture to store the MIG data structure. In some embodiments, MIG database 130 may associate a unique identifier with a specific MIG data structure. In some embodiments, MIG database 130 may store an encrypted MIG data structure. For example, upon creation of an MIG data structure, the MIG creation logical circuit 112 may encrypt the MIG data structure with the user's public key and store the encrypted MIG data structure within MIG database 130. In some embodiments MIG database 130 may include dynamic memory allocation for the MIG objects being stored. For example, if a modification to a specific MIG data structure exceeds the memory allocated to the MIG data structure, MIG database 130 may partition a larger partition of the database to store the new newly modified MIG data structure in the new location with the larger partition of allocated database storage.

Information storage devices 120 may include system metadata database 132. In some embodiments, system metadata database 132 may include of information about data throughout the system. In some embodiments system metadata database 132 may include a structured or unstructured storage architecture comprising system metadata. In some embodiments, system metadata may include authorization settings, wherein authorization settings include system level access rights and the role of the user device; and usage logs, wherein the usage logs include historical logs of system metadata changes, user device information, and a historical item generation log of all items generated in the system. For example, system metadata database 132 may store a master timestamp record of when MIG data structures were instantiated, modified or accessed. In some embodiments, system metadata database 132 may include general information about the system including file sizes, file names, location of files, and usage information. In some embodiments, system metadata database 132 may include aggregate information about the system. For example, system metadata database 132 may contain the size of total allocated storage as well as the remaining storage available to be used. In some embodiments, system metadata database 132 may be specified by one or more users. For example, the creator of the MIG data structure may specify that the system metadata store aggregate information about the total number of MIG data structures, average item generation models/MIG, etc.

In some embodiments, information storage devices 120 may include user database 134. In some embodiments user database 134 may include a structured or unstructured storage architecture comprising user information. In some embodiments, user information may include personal information such as name, email, phone number, age, sex etc. In some embodiments, user information may include user device information such as IP address, device identification code, digital wallet address, or other identification information capable of identifying the user device. In some embodiments, user information may include web level session information such as user name, user ID, browser, and associated web cookies. Web cookies are small pieces of data that are stored in a user's computer by a web browser which is communicated to and from web surfers when navigating the internet. In some embodiments, user database 134 may include access and authorization credentials for specific MIG data structures. For example, user database 134 may store the a user with read-only access to a specific MIG.

Computing system 100 may also include a communications interface 142. Communications interface 142 may be used to allow software and data to be transferred between computing system 100 and external devices. Examples of communications interface 142 may include a modem or softmodem, a network interface (such as an Ethernet, network interface card, WiMedia, IEEE 102.XX or other interface), a communications port (such as for example, a USB port, IR port, RS232 port Bluetooth® interface, or other port), or other communications interface. Software and data transferred via communications interface 142 may typically be carried on signals, which can be electronic, electromagnetic (which includes optical) or other signals capable of being exchanged by a given communications interface 142. These signals may be provided to communications interface 142 via a channel 144. This channel 144 may carry signals and may be implemented using a wired or wireless communication medium. Some examples of a channel may include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 110, storage unit 128, media 124, and channel 144. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing system 100 to perform features or functions of the disclosed technology as discussed herein.

In some embodiments, computing system 100 may be a part of a distributed system. A distributed computing system may include components that are located in different networked computers and that perform computation and store information by communicating and coordinating their actions through messages to one another. In some embodiments, a distributed storage system may be used in order to store the MIG data structure, and other information of the system. For example, a specific MIG data structure may be stored on all computers that have been given read access to the MIG data structure. In some embodiments, distributed storage systems may be used to keep backups and improve the fault tolerance of the system. For example, if one computer that stores an MIG data structure becomes deprecated and disconnects from the system, there may be a backup computer than can be easily accessed to retrieve the MIG data structure. Utilizing a distributed architecture may improve the performance, fault tolerance, and security of the computation and storage of data associated with computing system 100.

In some embodiments, computing system 100 may be a node in a blockchain network. For example, computing system 100 may be a single node in a distributed blockchain network wherein storage in the system is stored in a sequential, chronological, cryptographically linked list data structure. The computing systems may commute with one another through messages and consensus algorithm may be used to stay in sync with one another. The present disclosure provides systems and methods for securing and tracking computer generated items by using an MIG data structure. In some embodiments, the MIG data structure may implement cryptography, Merkle trees, layered authorization and access systems, secure file transfer, and secure storage systems. The systems and methods for securing and tracking computer generated items maximize efficiency through symbiotic use of cryptography and data structure, such as hashing and Merkle trees. In some embodiments, cryptography techniques such as hashing are used to identify unique components of the system. In some embodiments, specific data structure designed to maximize the efficiency of lookup times, such as hash tables, are used to store this information. In some embodiments, secure file transfer protocols are used such as Secure File Transfer Protocol (SFTP) or File Transfer Protocol Security (FTPS), which utilize Transport Layer Security (TLS) or Secure Socket Layer (SSL) encryption to secure file transfer in the system.

In some embodiments, the system may utilize Merkle trees as data structures to efficiently track computer generated items and each items relationship to item generation models of an MIG data structure. A generated test item may be compared to items that are in currently in the MIG data structures Merkle tree to determine uniqueness. The Merkle tree may be used by a user or third-party entity to audit the state of all generated items at specific timestamps.

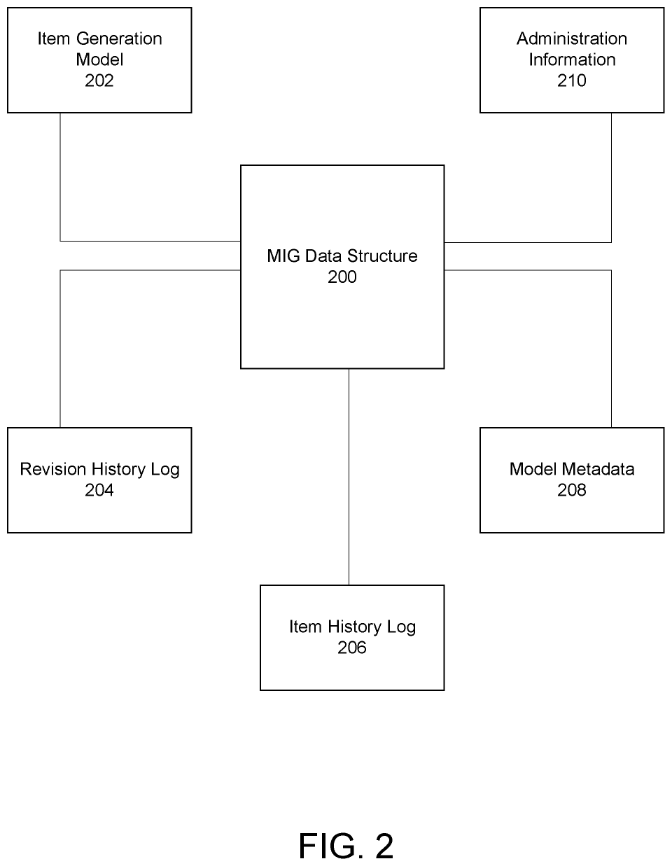

FIG. 2 is an illustration of an example MIG Data structure 200. In some embodiments, MIG data structure 200 may be created by MIG creation logical circuit 112. In some embodiments, MIG data structure 200 may be stored in MIG database 132. MIG data structure 200 may be encrypted before it is stored in MIG database 132. The encryption of MIG data structure 200 enhances the security and tracking of the usage of the MIG data structure. For example, if there was a data breach into MIG database 132, MIG data structure 200 would not be usable without proper decryption of the data structure. In some embodiments, MIG data structure 200 may be encrypted with the public key of associated with a user. For example, the user's private key must be applied to the encrypted MIG data structure in order to properly decrypt the encrypted MIG data structure.

In some embodiments, MIG data structure 200 may include an item generation model 202. In some embodiments item generation model 202 may include a structured template in which to generate test items. In some embodiments, the item generation model may specify the type of test item to be generated. For example, item generation model 202 may generate multiple choice test items, short answer test items, essay test items, or another type of question. In some embodiments, item generation model 202 may generate test items comprising different education topics such as mathematics, English, history, physics, etc. For example, item generation model 202 may be generate test items specific to algebra. In some embodiments, multiple choice test item may include a question, a list of potential choices, and the choice that correctly answers the question. In some embodiments, short answer question may include open-ended questions that require an examinee to create a response limited in length. In some embodiments, an essay question may include an open-ended question that requires an examinee to respond in a sentence, paragraph, or short composition. Essay questions are similar to short answer questions but may require more in-depth and comprehensive response in order to receive full credit.

In some embodiments, item generation models include test item templates, variable elements, content values, and associated answers, wherein the test item templates are used in a process for generating items comprising varying the variable elements in the test item templates with the content values and determining the associated answers. In some embodiments, item generation models contain the components in an assessment task that can be used for item generation. These components may include the stem, the options, and the auxiliary information. The stem contains context, content, item, and/or the question the examinee is required to answer. The options include a set of alternative answers with one correct option and one or more incorrect options or distracters. Both stem and options are required for multiple-choice item models. Only the stem is created for constructed-response item models. Auxiliary information includes any additional content, in either the stem or option, required to generate an item, including text, images, tables, graphs, diagrams, audio, and/or video. The stem and options can be further divided into elements. An element is the specific variable in an item model that is manipulated to produce new test items. An element may be denoted as either a string, which is a non-numeric value, or an integer, which is a numeric value. By systematically manipulating elements, new items can be created.

In some embodiments, item generation models may include a single layer of elements and may produce new assessment tasks by manipulating the elements in the model. In some embodiments, a layer of elements includes set of elements. In some embodiments, an item model may include an multi-layered layer of elements (e.g. an n-layer item model). N-layer item models may produce items by manipulating a relatively large number of elements at two or more levels in the model. In some embodiments, one-layer models may be a linear set of generative operations using a set of elements at a single level. In some embodiments, n-layer models permits manipulations of a nonlinear set of generative operations, such as embedding elements within one another that allow the creation of elements at multiple levels. The generative capacity of the n-layer model may be an improvement to the conventional 1-layer models. The n-layer structure can be described as a model with multiple layers of elements, where each element can be varied simultaneously at different levels to produce different items.

In some embodiments, MIG data structure 200 may include a revision history log 204. In some embodiments, revision history log 204 may include a chronological record of modifications made to MIG data structure 200. In some embodiments, revision history log 204 may record the information when the MIG data structure was first created. For example, revision history log may store the timestamp, author, and initial information associated with the MIG data structure when it was created in the revision history log. In some embodiments, revision history log 204 may be written by the MIG modification logical circuit upon modifying the MIG data structure in storage. In some embodiments, revision history log 204 may include of the modifications that were made to the MIG data structure itself. For example the details of modifications made to the item generation model of a MIG data structure, such as layer modifications, language modifications, and any structural modifications may be stored in the revision history log 204.

In some embodiments, MIG data structure 200 may include an item history log 206. In some embodiments, item history log 206 may include a chronological record of generated items and associated information from an item generation model. In some embodiments, generated items may be stored in an array wherein chronological order is maintained by the index position of the generated items. For example, a generated test item would be appended to the end of the item history log array. In some embodiments, generated items may be stored in a hash table wherein each generated test item may be labeled and stored with an associated hash in order to identify the test item in the item history log. Storing the item history log as a hash table may offer an improvement in the speed of accessibility to test items. For example, when determining if there is duplicate generated test item, a hash table can perform a hash comparison in linear time as oppose to an array which must parse the entire data structure to determine if there is no unique item. In some embodiments, item history log 206 may include a Merkle tree capable of storing relational information between generated items and item generation models. In some embodiments, item history log 206 may include an array, hash table, or Merkle tree either individually or in combination.

In some embodiments, item history log 206 may include a Merkle tree wherein each item is a child of the item generation model that was used to create the item. A Merkle tree is a directed graph comprising of nodes connected by vertices, wherein the nodes of Merkle tree include a root node, non-leaf nodes, and leaf nodes. In some embodiments, leaf nodes of the Merkle Tree (nodes without children) each contain a cryptographic hash of the data stored in the leaf node. In some embodiments, the Merkle tree of the item history log may be used to determine and track the relationship between item generation models and generated items. In some embodiments, the item history log may include a distributed ledger wherein each modification and generated item is written as a transaction to the ledger. A distributed ledger is a replicated, shared, and synchronized data storage mechanism is stored across multiple computing systems. In some embodiments, the item history log may be distributed across multiple computers associated with stakeholders that have been specified in the administration information of the MIG data structure.

In some embodiments, generated items stored in item history log 206 may be labeled with information comprising model metadata 208. In some embodiments, generated items may be labeled with a hash of the generated item data. In some embodiments, model metadata 208 may not be included in the hash used to identify the generated items. This ensures the hash of items are not unique based purely on model metadata, which may not be displayed to examinees. In some embodiments, information stored in the item history log may include information regarding the administration of a test item in the context of an examination. For example, item history log 206 may include of information such as the location where the test was administered, the time the test item was administered, and information about how the test item was answered by the examinees. In some embodiments, generated items stored in the item history log may be labeled with information collected from the test administration entity that used the MIG to generate test items. In some embodiments, there may be a feedback mechanism in generated items where information can be collected from test administration entities. In some embodiments, the feedback mechanism may collect information through user input corresponding to test items. In some embodiments, the feedback mechanism may collect information automatically. For example, the feedback mechanism may have access to test administrators (e.g. examiners) database, where information such as, user responses, a percentage that a test item was correctly answered, the time a question or test item was answered or accessed, the location of a device that accessed a test item, or other information corresponding to test item activity can be collected and added to the metadata of the test item for future analysis or organization.

In some embodiments, MIG data structure 200 may include model meta metadata 208. In some embodiments, model metadata 208 may include additional information about the item generation model and generated items. For example, model metadata 208 may include information about users and entities associated with the MIG data structure such as user device information, entity the user is associated with, etc. In some embodiments, model metadata 208 may include information associated with the test or examination that have been administered with the item generation model. For example, model metadata may include geographical information, examination administration information, demographic information, etc. In some embodiments, model metadata 208 may include aggregate usage information about the MIG data structure. For example, model metadata may include information regarding the most common testing facilities, regions, grade levels, skill levels, or circumstances in which the MIG data structure was used. In some embodiments, model metadata 208 may include information related to the effectiveness or difficulty of the generated items, based on, for example, feedback received from examinees. For example, the MIG data structure may assess store the correctness percentage of administered generated items.

In some embodiments, model metadata 208 may include information collected from the test administration entity that used the MIG to generate test items, as described herein. In some embodiments, model metadata 208 may use a feedback mechanism where information can be collected from test administration entities. In some embodiments, the feedback mechanism may collect information through user input. In some embodiments, the feedback mechanism may collect information automatically. In some embodiments, model metadata 208 may collect information from item history log 206 that is associated with the specific model metadata information. For example, model metadata 208 may collect information from the item history log that was labelled with a specific test administration facility used to assess and analyze information from that specific examination.

In some embodiments, MIG data structure 200 may include administration information 210. In some embodiments, administration information 210 may include user access rights to the MIG data structure. In some embodiments, administration information 210 may include demographic access specifications. For example, administration information may include a list of locations where an MIG can be used to generate test items for computer generated tests. In some embodiments, administration information may include tiered access rights specification. For example, administration information may store information regarding entities who can use the MIG data structure to generate test items as well as information regarding entities that can modify the MIG data structure.

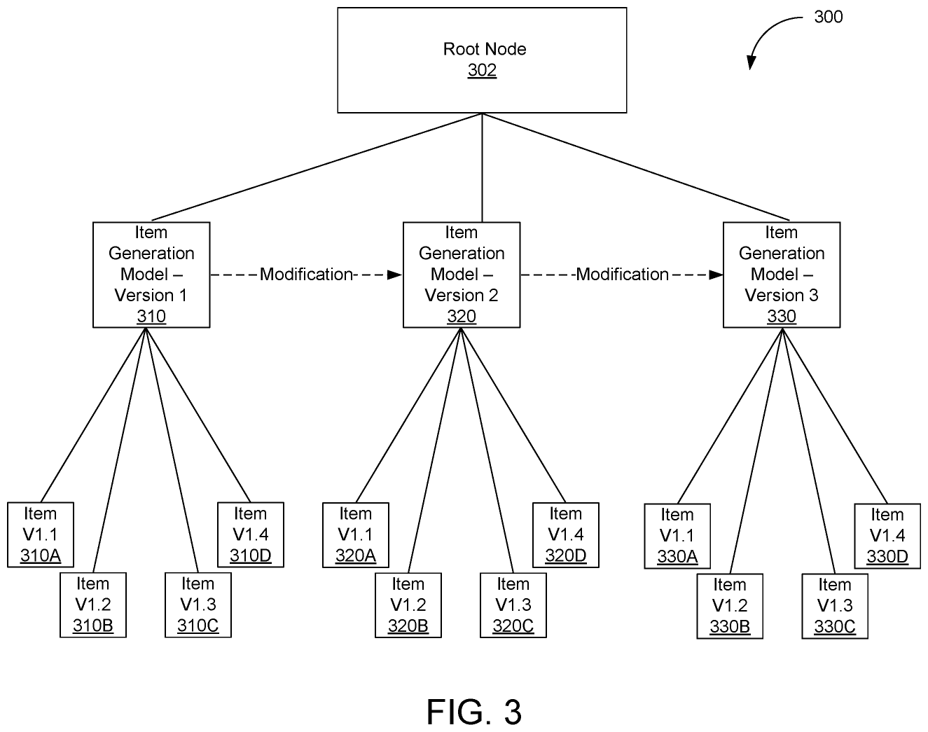

FIG. 3 illustrates a diagram of a Merkle tree 300 in the item history log of an MIG data structure containing information about the relationship between item generation models and generated items. In some embodiments, Merkle tree 300 includes of a root node corresponding to the item history log. In some embodiments, Merkle tree 300 includes non-leaf nodes corresponding to item generation models. In some embodiments, non-leaf nodes corresponding to an item generation model may contain information about the version of the item generation model. In some embodiments, non-leaf nodes may contain information related to the relationship to the non-leaf node corresponding to the previous version of item generation model. In some embodiments, each modification to Merkle tree 300 is timestamped and recorded. In some embodiments, Merkle tree 300 includes of leaf nodes corresponding to computer generated items. In some embodiments, leaf nodes include hashes of the data contained in a specific generated test item. In some embodiments, hashes of the generated items may be determined from a hash function. A hash function is a mathematical algorithm that maps data of arbitrary size to fixed sized values. Hashes can be used as identification for a specific generated test item. In some embodiments the hash function used in Merkle tree 300 may be specified by the administrator of the MIG data structure. For example, the administrator of the MIG data structure may specify SHA-256 as the hash function to be used in the Merkle tree in the item history log.

In some embodiments, Merkle tree 300 may include a root node 302. In some embodiments, root node 302 may include a node corresponding with the item history log of the MIG data structure. In some embodiments, the root node may include the highest node in the Merkle tree structure. In some embodiments, the root node may have one or more children nodes. In some embodiments, the root node may have no sibling nodes or parent nodes. In accordance with the disclosure, the root node may be used to determine the state of the MIG data structure in an efficient and secure manner. For example, if an auditor needs to determine all the generated items at a specific timestamp, they could verify all the generated items with the root hash associated with the Merkle Tree at the time they want to audit the information.

In some embodiments, Merkle tree 300 may include non-leaf nodes 310, 320, and 330. In some embodiments, non-leaf nodes may include nodes associated with item generation models of the MIG data structure. In some embodiments, non-leaf nodes may correspond with specific version of item generation models of the MIG data structure. In some embodiments, modifying the item generation model of the MIG data structure may create a new non-leaf node of the Merkle Tree. For example, a modification of the item generation model of a MIG data structure may create a new record in the revision history log of the MIG data structure associated with new version of the item generation model, wherein information of the new version of the item generation model in the revision history log may be used to create a new non-leaf node in the Merkle Tree of the item history log (e.g. node 320). Subsequently, any test items generated from the new version of the item generation model will be added as children nodes from the non-leaf node of the Merkle tree associated with the new version of the item generation model.

In some embodiments, Merkle tree 300 may include leaf nodes 310A-310D, 320A-320B, and 330A-330D. In some embodiments, leaf nodes may include nodes corresponding to generated items. In some embodiments, leaf nodes may store hashes of the computer generated items. In some embodiments non-leaf nodes may have siblings. For example, a non-leaf node may have a sibling node corresponding to the previous version of the item generation model. In some embodiments, generating a new test item may create a new leaf node of the Merkle tree. For example, generating a test item may create a new record of in the item history log of the MIG data structure associated with the generated test item wherein information from the new generated test item in the item history log may be used to create a new leaf node in the Merkle Tree of the item history log (e.g. node 320A). In some embodiments, the new leaf node of the Merkle Tree will be the child of the non-leaf node associated with the item generation model used to generate the test item. For example, if Item generation model version 2 was used to generate a test item, than the test item will be a child of the non-leaf node associated with item generation model version 2.

In some embodiments, Merkle tree 300 may be instantiated upon creation of the MIG data structure. For example, Merkle tree 300 may be instantiated by allocating fixed or dynamic storage in the MIG data structure and storing the root node associated with the item history log and a non-leaf node associated with the original item generation model of the MIG data structure. In some embodiments, generating test items may include instantiating a leaf node of the Merkle tree, associating the leaf node with the test item, and connecting the leaf node to the non-leaf node associated with the item generation model. In some embodiments, modification to the item generation model of the MIG data structure may include instantiating a new non-leaf node, associating the non-leaf node with the new version of the item generation model, and connecting the non-leaf node to the root node associated with the item history log of the MIG data structure.

In some embodiments, each node comprising Merkle tree 300 is labeled with a hash comprising of the data stored in each node. In some embodiments, each parent node stores the hash of all of its children nodes. A child node may be any node below a given node in the tree hierarchy structure, and a parent node may be any node above a given node in the tree hierarchy structure. For example, the root node may be the parent of the non-leaf node, and the non-leaf node may be the child of the root node. In some embodiments, the Merkle tree may be used to audit the MIG data structure at any specific timestamp. For example, if an entity would like to determine all the test items that have been generated at a specific timestamp, they could use the root nodes hash at the known timestamp to regenerate the Merkle tree at the specific timestamp. In some embodiments, the Merkle tree may be used to validate whether a specific test item came from a specific item generation model. For example, a proof can be performed to determine whether a leaf nodes hash associated with a test item is included in a non-leaf nodes hash associated with an item generation model.

Using Merkle trees to store information regarding item generation models and generated items provide an improvement over traditional solutions to the integrity and validity of the data storage. Merkle trees also provide an efficiency improvement over previous access and validity solutions as they are an extremely light weight data structure with computationally fast proofs to determine the existence of an item in the Merkle tree. Furthermore, in distributed systems, Merkle trees require minimal data to be sent across networks in order to communicate the validity of proofs and maintain synchronization across the different computers in the distributed system.

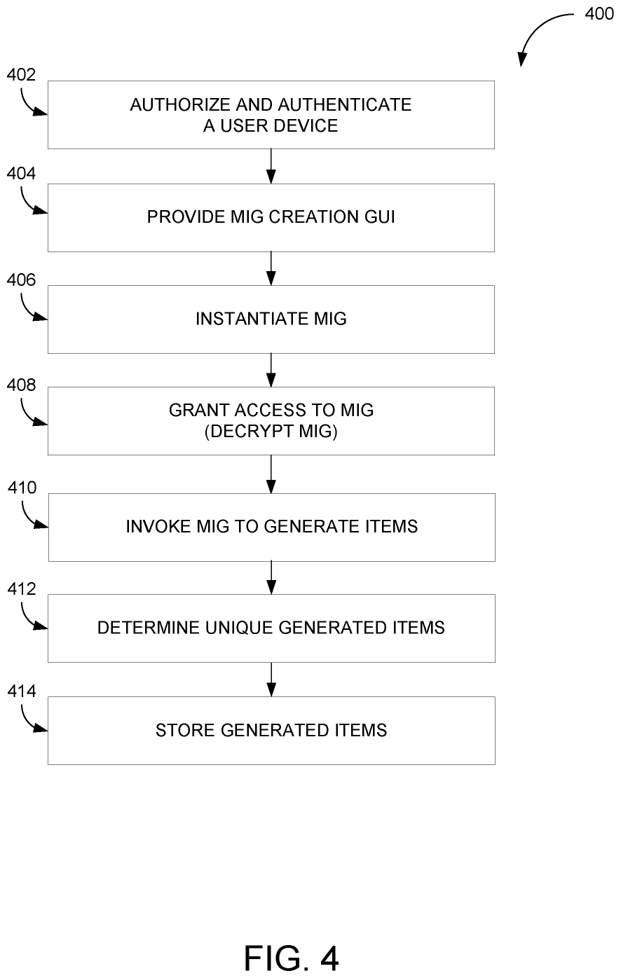

FIG. 4 is an example method 400 for a system for tracking and securing computer generated items. In some embodiments, method 400 includes of authorizing and authenticating a user, creating an MIG data structure, and utilizing the MIG data structure to generate test items. In some embodiments, method 400 may utilize MIG creation logical circuit 112, item generation logical circuit 116, and security logical circuit 118 to execute operations. For example, security logical circuit 118 may authorize and authenticate a user in order for the MIG creation logical circuit 112 to create an MIG data structure. In some embodiments, method 400 may store information in the MIG database 132.

In embodiments of the disclosure, method 400 may include encrypting the MIG data structure in order to secure access and usage. In certain implementations, the method may include decrypting the MIG data structure to be used upon authenticating and authorizing a user device. In some embodiments, the encryption and decryption process may be performed using public-key cryptography. In certain implementations, the MIG data structure may be encrypted using a specific user's public key and will be decrypted using the user's private key. In some embodiments, there will be a digital key that may be distributed to different users upon being granted access to use an MIG data structure. In some embodiments, there may be tiered access rights to an MIG data structure. For example, some users may be granted read-only access to and MIG data structure, while other users may have read-write access.

Operation 402 may include authorizing and authenticating a user device. In some embodiments, operation 402 may include receiving a user ID and password from a user device, and comparing it to information stored in user database 136. Upon authorization of correct user credential, and the user device confirmation mutual authentication, an secure connection is established between the server and user device. In some embodiments, operation 402 may include authentication protocols specifically designed to transfer a user device trying to connect to computing system 100. In some embodiments, a Point-to-Point Protocol (PPP) may be used for authentication such as Password Authentication Protocol (PAP), Challenge-Handshake Authentication protocol (CHAP), or Extensible Authentication Protocol (EAP). In some embodiments, operation 402 may include an authentication, authorization, and accounting (AAA) protocol. For example, AAA protocols such as Terminal Access Controller Access-Control System (TACACS), Remote Authentication Dial-In User Service (Radius), or the Diameter protocol may be used to authorize and authenticate a user device.

Operation 404 may include providing and MIG creation GUI to the user device for display and interaction. In some embodiments, the MIG creation GUI may include a form display comprising labels and associated form fields. For example, MIG creation GUI may be a form wherein there is labels of the different components of the MIG data structure (e.g. item generation model, creator, access list, etc.), wherein form fields allow the user to input information required to create an MIG data structure. In some embodiments, MIG creation GUI includes a button that invokes execution of the instantiation of the MIG data structure.

Operation 406 may include instantiating the MIG data structure. In some embodiments, instantiating the MIG data structure may include writing the MIG data structure to storage memory. In some embodiments, operation 406 may include allocating storage in computing system 100 for the MIG data structure to be stored. In some embodiments, instantiating the MIG data structure may include invoking execution of the MIG creation logical circuit 112, wherein an MIG data structure is created and stored with the information specified in the form fields of the MIG creation GUI provided in operation 404.

Operation 408 may include granting access to the MIG data structure. In some embodiments, operation 408 may include performing additional authorization and authentication processes of a user device with the system and determining the user device has access rights or other permissions associated with the MIG data structure. For example, after a MIG data structure is created, additional authorization and authentication of a user device based on information within the created MIG data structure may be required to ensure proper usage of the MIG data structure. In some embodiments, operation 408 may invoke the execution of security logical circuit 118 that may enable a user to read, write, or modify the MIG data structure. In some embodiments, granting access may include identifying access rights of a user from information stored in the administration information of the MIG data structure. In some embodiments, operation 408 may include a two-factor authentication process wherein the user must provide information that validates an identity in order to access the MIG data structure. For example, upon instantiating a MIG data structure, the user may be sent a message to a separate device confirming they are the individual or entity accessing the MIG data structure.

Operation 410 may include invoking the MIG to generate test items. In some embodiments, operation 410 may include using item generation logical circuit 116 to use the item generation model of the MIG data structure to generate test items. In some embodiments, generating test items includes assembly of elements in the specific format defined in the item generation model. In some embodiments, generating test items includes an assembly task that may be conducted with a computer-based assembly system due to the combinatorial attributes of the process. In some embodiments, an item generation may correspond to a cognitive model developed by subject matter experts of the testing subject, as described herein and by reference. For example a computer-based system may assemble the content specified in an item model, subject to elements and constraints articulated in the cognitive model. In some embodiments, iterations are conducted to assemble all possible combinations of elements and options, subject to the constraints. In some embodiments, the use of constraints, all of the variable content (i.e., values for the integers and strings) would be systematically combined to create new items. Constraints may serve as restrictions that may be applied during the assembly task in order for meaningful items are generated. To begin, the computer-based assembly system may read an item model in the form of an XML (Extensible Markup Language) file. The content for the item model may be formatted to adhere to specific requirements of the test which the item is being generated for.

In some embodiments, generating test items is presented on a GUI to a user. The generated test item GUI may include a dialogue box which is presented to the user to specify information associated with the generated test item such as the item generation model and what the examination the item is being generated for. For example, the item generation model may be loaded from the current item model which is specified in the MIG data structure. In some embodiments, the user may save a separate key under the answer key option. In some embodiments, the user may specify generator options. In some embodiments, generator options include size of the generated item bank, the order of the options, and the number of options for each generated test item. In some embodiments, once all of the information has been properly specified in the dialogue box, the item generation logical circuit 116 may be executed.

In some embodiments, generating test items may include tagging each test item with the model metadata of the MIG data structure. In some embodiments, model metadata information is specified by the user device that created the item generation model. In some embodiments, model metadata information may automatically default to information based on other components of the MIG data structure. For example, model metadata information may include user device information and timestamp information about when the item generation model was created, when not being explicitly specified by the user.

Operation 412 may include, determining uniquely generated items. In some embodiments, operation 412 may include comparing a generated test item to all previous test items in the item history log of the MIG data structure. For example, operation 412 may compute a hash of a generated test item and perform a lookup in the item history log to determine if the generated test item is unique. In some embodiments, operation 412 may comprise hashing the generated test item with a hash function and comparing it to the hashes of previously generated items.

In some embodiments, operation 412 may delete the generated test items that have been identified as duplicates. For example, if the MIG data structure generated a test item that was identical to a test item generated for a previous exam the test item may be deleted and never administered. In some embodiments, model metadata may be used to determine whether or not to delete a duplicate generated test item. In some embodiments, model metadata may include information regarding the test administration of the generated test item, wherein comparing certain conditions, such as the time where a generated test item is administered determines whether or not to delete the generated test item. For example, the duplicate test item may be deleted if the time difference between the previous generated test item exceeds a specific time threshold (e.g. 2 days).

In some embodiments, operation 412 may involve not delete generated items that have been identified as duplicates. In some embodiments, operation 412 may add include additional metadata in the generated test item regarding the previous test item that has been identified as a duplicate. In some embodiments, model metadata may be used to determine whether or not to delete a duplicate generated test item. In some embodiments, model metadata may include information regarding the test administration of the generated test item, wherein comparing certain conditions, such as the time where/when a generated test item is administered, determines whether or not to delete the generated test item. For example, the duplicate test item may not be deleted if the time difference between the previous generated test item does not exceed a specific time threshold (e.g. 24 hours).

In some embodiments, a consensus algorithm may be implemented as part of system to verify that there is agreement between entities regarding how instantiate, secure, track, modify, or verify generated items. The consensus algorithm (or consensus decision technique) implemented may include a protocol (or set of rules) used to ensure the accuracy and trustworthiness of the item information to be recorded to the storage of the computing system. The method for reaching a consensus and determining the global state may utilize one or more different schemes. In some implementations, the number, percentage, and/or other metric used to determine whether a consensus has been achieved may be predefined or set according to particular needs. For example, operation 412 may rely on consensus algorithm that requires user feedback to determine whether or not to delete a duplicate test item. The consensus decision technique may require a specific percentage of users with administrative rights to the MIG to confirm to the deletion of the generated test item in order for the test item to be deleted. In some embodiments, the consensus decision technique may have a default if there is not necessary user feedback. For example, operation 412 may always delete duplicate test items if over 50% of the administrative users of the MIG do not provide feedback to determine whether or not to delete the generated test item.

In some embodiments, consensus may be the mechanism used to determine whether to write information to a database, agreeing on the identity of a user in the system, and computing system replication. In some embodiments, computing system 100 may implement authenticated communication channels, binary consensus, asynchronous systems, synchronous systems, and Byzantine Fault Tolerance algorithms. In some implementations, the consensus decision technique used may be based on a consensus framework with predefined methods or algorithms. For example, proof-of-work (PoW), proof-of-stake (PoS), Proof of Elapsed Time (PoET), proof of custody, proof-of-authority (PoA), and/or other consensus algorithms may be used. In various implementations, a virtual machine may be implemented as part of the computing system acting as a participant in the blockchain system. In some embodiments, consensus may be controlled by a single entity or master computing system that determines what information to store and broadcast out to the network.

Operation 414 may include storing generated items in the MIG data structure. In some embodiments, operation 414 may include writing the generated test item to the item history log. In some embodiments, operation 414 may write the generated test item to an item history log table comprising of all generated items of the MIG data structure. In some embodiments, storing generated items includes creating a new leaf node in the Merkle Tree in the item history log of the MIG data structure. For example, generating a test item may create a new record of in the item history log of the MIG data structure associated with the generated test item wherein information from the new generated test item in the item history log may be used to create a new leaf node in the Merkle Tree of the item history log (e.g. node 320A). In some embodiments, the new leaf node of the Merkle Tree will be the child of the non-leaf node associated with the item generation model used to generate the test item. For example, if Item generation model version 2 was used to generate a test item, than the test item will be a child of the non-leaf node associated with item generation model version 2.

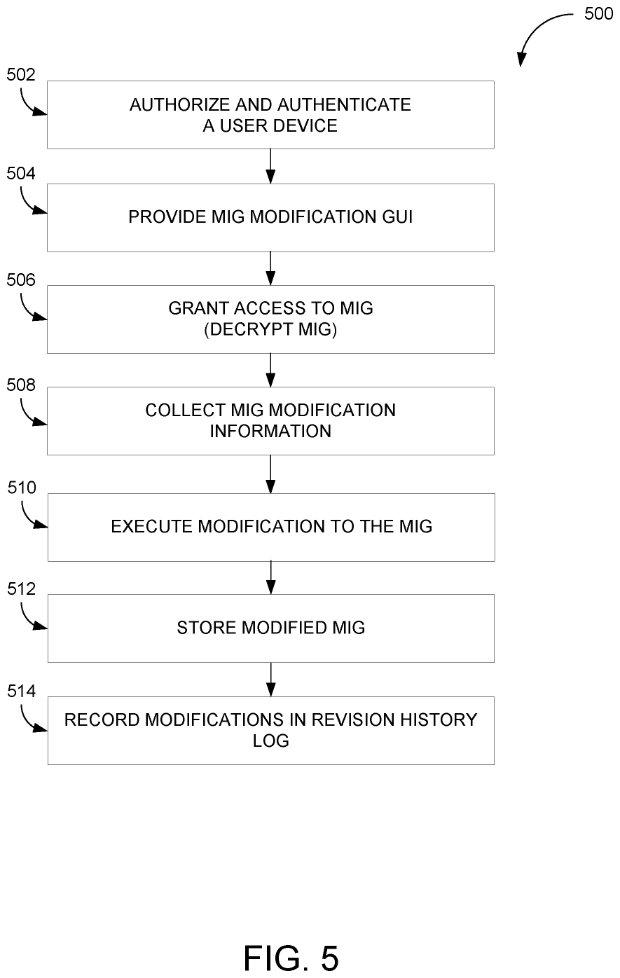

FIG. 5 illustrates a flowchart diagram of method 500 for modifying a MIG data structure. In some embodiments, method 500 includes authorizing and authenticating a user, accessing a MIG data structure, modifying the MIG data structure, and storing the modifications of the MIG data structure in the MIG data structure. In some embodiments, method 500 may utilize MIG modification logical circuit 114 and security logical circuit 118 to execute operations. For example, security logical circuit 118 may authorize and authenticate a user in order for the MIG modification logical circuit 114 to modify an MIG data structure. In some embodiments, method 500 may modify information stored in MIG database 132. In some embodiments, method 500 may record modification information in the revision history log and the item history log of the MIG data structure being modified.

Operation 502 may include authorization and authenticating a user device. In some embodiments, operation 502 may include receiving a user ID and password from a user device, and comparing it to information stored in user database 136. Upon authorization of correct user credential, and the user device confirmation mutual authentication, an secure connection may be established between the server and user device. In some embodiments, operation 502 may include identifying access rights of a user from information stored in the administration information of the MIG data structure. In some embodiments, operation 502 may include authentication protocols specifically designed to transfer a user device trying to connect to computing system 100. In some embodiments, a Point-to-Point Protocol (PPP) may be used for authentication such as Password Authentication Protocol (PAP), Challenge-Handshake Authentication protocol (CHAP), or Extensible Authentication Protocol (EAP). In some embodiments, operation 502 may include an authentication, authorization, and accounting (AAA) protocol. For example, AAA protocols such as Terminal Access Controller Access-Control System (TACACS), Remote Authentication Dial-In User Service (Radius), or the Diameter protocol may be used to authorize and authenticate a user device.

Operation 504 may include providing an MIG modification GUI to the user device. In some embodiments, the MIG modification GUI may include a form display comprising labels and associated form fields. For example, MIG modification GUI may include a form wherein there is labels of the different components of the MIG data structure (e.g. item generation model, creator, access list, etc.) wherein form fields allow the user to input information required to modify an MIG data structure. In some embodiments, MIG modification GUI includes a button that invokes execution of the modification of the MIG data structure. In some embodiments, the MIG modification may interact with security logical circuit 118 to determine what information to display. For example, MIG modification GUI may include a dropdown interface wherein the user may choose an MIG data structure that they have access rights to modify.

Operation 506 may include granting access to the MIG data structure. In some embodiments, operation 506 may include authorizing and authenticating a user device with the system and determining the user device has access rights to the MIG data structure. In some embodiments, operation 506 may invoke the execution of security logical circuit 118, wherein the security logical circuit 118 performs a decryption process of the stored encrypted MIG data structure. In some embodiments, operation 506 may include determining the location of the MIG data structure in memory and retrieving the MIG data structure from MIG database 130. In some embodiments, operation 506 may include a two-factor authentication process wherein the user must provide information that validates an identity in order to access the MIG data structure. For example, upon selected a specific MIG data structure in a dropdown menu, the user may be sent a message to a separate device confirming they are the individual or entity accessing the MIG data structure to be modified.

Operation 508 may include collecting MIG modification information from the MIG modification GUI. In some embodiments, operation 508 may include sending information inputted by the user in the MIG modification GUI to the system server and processing the information in order to determine how and what to modify of the specified MIG data structure. For example, a user may specify one or more users that are allowed to the access the MIG data structure to generate test items. The differences between the stored MIG data structure and the modified MIG data structure would be additional users that have been added to administration information of the modified MIG data structure. In some embodiments, determining the difference between the stored MIG data structure and the MIG data structure specified in the MIG modification GUI may include hashing the modified data structure and comparing it to information stored in the revision history of the MIG.

Operation 510 may include executing modification of the MIG data structure. In some embodiments, operation 510 may include providing the collected MIG modification information as input to the MIG modification logical circuit 114. In some embodiments, operation 510 may include determining the location of the components of the MIG data structure being modified. In some embodiments, executing modification of the MIG may include performing sanitation and quality assurance tests to ensure proper use, and modifications were made. For example, there may be a check in order to identify banned words, which will stop execution of the modification of the MIG data structure and notify the user of the problem. data structure may include modifying the MIG data structure in temporary memory. In some embodiments, operation 510 may include instantiating a non-leaf node in the Merkle tree of the item history log in the MIG data structure and connecting is to the root node of the Merkle tree.

Operation 512 may include storing the modified MIG data structure in memory. In some embodiments, operation 512 may include overwriting the stored MIG data structure with the modified version that was stored in a temporary memory location. In some embodiments, operation 512 may include encrypting the MIG data structure to be stored. In some embodiments, the modified component of the MIG data structure may be administration information or model metadata information. When the administration information is modified, operation 512 may include adding, deleting, or modifying existing access rights of user devices. For example, upon deleting a user from the access rights list of an MIG data structure, the user's information in the administration information of the MIG data structure may be deleted, labeled inactive, or blacklisted from accessing the MIG data structure. When model metadata information is modified, operation 512 may include adding, deleting, or modifying metadata that is collected from the MIG data structure. For example, if the MIG data structure changes where the target examinee demographic is a different grade than previously, the model metadata may be changed to label the target grade level accordingly.

In some embodiments, the modified component of the MIG data structure may include the item generation model. When the item generation model of the MIG data structure is modified, operation 512 may include creating a new non-leaf node in the Merkle Tree in the item history log of the MIG data structure. For example, a modification of the item generation model of a MIG data structure will create a new record in the revision history log of the MIG data structure associated with new version of the item generation model wherein information of the new version of the item generation model in the revision history log may be used to create a new non-leaf node in the Merkle Tree of the item history log (e.g. node 320). Subsequently, any test items generated from the new version of the item generation model will be added as children nodes from the non-leaf node of the Merkle tree associated with the new version of the item generation model.

In operation 514, method 500 may include recording the modifications made to the MIG in the revision history log of the MIG. In some embodiments, operation 514 may include determining the differences between the modified MIG data structure and the previous version of the MIG data structure. The different of the modified MIG data structure from the previous version of the MIG data structure may be written to the revision history log. In some embodiments, operation 514 may include hashing the modified MIG data structure to be recorded in the revision history log of the MIG data structure. In some embodiments, operation 514 may include collection model metadata and label the modified MIG data structure in the revision history log. In some embodiments, operation 514 may collect test item metadata produced from the previously stored MIG revision and add test item metadata to the previously stored MIG revision in the revision history log.

Terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

Each of the processes, methods, and algorithms described in the preceding sections may be embodied in, and fully or partially automated by, software components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A system for tracking and securing computer generated items, the system comprising:
a computing device configured to communicate with a user device over a network, the computing device comprising a processor and a graphical user interface;
a non-transient memory with computer executable instructions embedded thereon, the computer executable instructions configured to cause the processor to:
authenticate and authorize the user device;
grant the user device access to an encrypted model item generation (MIG) data structure stored in a memory of the computing device, the MIG data structure comprising an item generation model, a revision history log, an item history log, administration information, and model meta-information;
decrypt the stored MIG data structure stored in memory of the computing device;
generate a plurality of items based upon the item generation model and model metadata; and
record the plurality of generated items in the item history log, wherein the item history log comprises, for each of the plurality of generated items, a unique hash, a generation timestamp, and the model meta-information.

2. The system of claim 1, wherein authenticating and authorizing the user device comprises validating the user device credentials and retrieving access rights of the user device, respectively.

3. The system of claim 1, wherein the item history log further comprises a Merkle tree, specifying the relationship between the item generation model and the plurality of generated items, wherein the root of the Merkle tree is associated with the item history log, the non-leaf nodes of the Merkle tree are based on the item generation model, and each leaf of the Merkle tree is based a generated item.

4. The system of claim 3, wherein modifications to the item generation model creates a new non-leaf node of the Merkle tree.

5. The system of claim 1, wherein modifications to the item generation model comprise modifications to the administration information, and modifications to the model metadata are stored in the revision history log of the MIG data structure or on a blockchain.

6. The system of claim 1, wherein the item generation model comprises test item templates, variable elements, content values, and associated answers, wherein the test item templates are used in a process for generating items comprising varying the variable elements in the test item templates with the content values and determining the associated answers.

7. The system of claim 6, wherein the test item templates comprise an n-layer model that permits manipulations of a nonlinear set of generative operations using variable elements at multiple levels, wherein the set of generative operations comprises defining a problem scenario, identifying sources of information for said problem, and logically interrelating variable elements and constraints of said sources of information which define said problem scenario.

8. The system of claim 1, wherein items are tagged with the model metadata, wherein the model metadata is specified by the user device that created the item generation model.

9. The system of claim 1 wherein the plurality of generated items are processed through a hashing algorithm to determine the unique hash for each generated item, wherein the unique hash is used to identify items, check for duplicates, and determine the relationship between the item generation model and the item.

10. The system of claim 1, further comprising system metadata, wherein the system metadata comprises:
system level authorization settings, wherein system level authorization settings comprise access rights and the role of the user device for system administrative processes; and
usage logs, wherein the usage logs comprise historical logs of system metadata changes, user device information, and a historical item generation log of all items generated in the system.

11. A computer-implemented method for tracking and securing computer generated items, the method comprising:
authenticating and authorizing a user device;
granting the user device access to an encrypted model item generation (MIG) data structure stored in a memory of the computing device, wherein the MIG data structure comprises an item generation model, a revision history log, an item history log, administration information, and model meta-information;
decrypting the stored MIG data structure stored in memory of the computing device;
invoking the MIG data structure to generate a plurality of test items;
determining the uniqueness of the generated items by comparing generated items to items stored in the item history log; and
recording the plurality of generated items in the item history log, wherein the item history log comprises, for each of the plurality of generated items, a unique hash, a generation timestamp, and the model meta-information;
wherein authenticating and authorizing the user device comprises validating user device credentials and retrieving access rights of the user device in the memory of the computing device.

12. The method of claim 11, further comprising exporting the stored MIG data structure to a computer system.

13. The method of claim 11, the item history log further comprises a Merkle tree, specifying the relationship between the item generation model and the plurality of generated items, wherein the root of the Merkle tree is based on the item generation model and each leaf of the Merkle tree is based a generated item.

14. The method of claim 11, wherein the item templates comprise an n-layer model that permits manipulations of a nonlinear set of generative operations using elements at multiple levels, wherein the set of generative operations comprises defining a problem scenario, identifying sources of information for said problem, and, logically interrelating elements and constraints of said sources of information which define said problem scenario.

15. A computer-implemented method for creating and modifying a MIG data structure, the method comprising:
authenticating and authorizing a user device;
providing a graphical user interface to a user device to specify the MIG data structure information;
collecting MIG data structure information specified as input in the GUI, the MIG data structure comprising an item generation model, a revision history log, an item history log, administration information, and model meta-information; and
instantiating the MIG data structure, encrypt the MIG data structure, and store the encrypted MIG data structure in memory.

16. The method of claim 15 further comprising:
granting the user device access to the data structure stored in a memory of the computing device, wherein the MIG data structure comprises an item generation model, a revision history log, an item history log, administration information, and model meta-information;
providing a GUI to the user device to specify modifications to the MIG data structure;
collecting modification information corresponding to modifications to the MIG data structure specified as input in the GUI, wherein the modification information comprises:
changes to the item generation model;
changes to the model metadata;
changes to the administration information;
storing in memory of the computing device the modifications of the MIG data structure; and
storing, in the revision history log of the MIG data structure or on a blockchain, the collected MIG data structure information and the modification information to the MIG data structure.

17. The method of claim 15, wherein the item history log further comprises a Merkle tree specifying the relationship between the item generation model and the plurality of generated items, wherein the root of the Merkle tree is based on the item generation model and each leaf of the Merkle tree is based on a generated item.

18. The method of claim 16, wherein modifications to the item generation model instantiates a new Merkle tree root.

19. The method of claim 16, wherein the plurality of generated items are processed through a hashing algorithm to determine the unique hash for each generated item, wherein the unique hash is used to identify items, check for duplicates, and determine the relationship between the item generation model and the item.

20. The method of claim 15 further comprising specifying system metadata, wherein system metadata comprises:
authorization settings, wherein authorization settings comprise access rights and roles of user devices to the system; and
usage logs, wherein usage logs comprise historical logs of system metadata changes, user device information, and a historical item generation log of all items generated in the system.
